(19) United States
(12) Patent Application Publication
(10) Pub. No.: US 2008/0000880 A1
(43) Pub. Date: Jan. 3, 2008

(54) System and method for treating a coating on a substrate

(76) Inventors: Bao Feng, Dunlap, IL (US); Ondrej Racek, Peoria, IL (US); Mahmoud Abdel Fattah Taher, Peoria, IL (US); Bo Shi, Peoria Heights, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/477,947

(22) Filed: Jun. 30, 2006

(51) Int. Cl. B23K 26/00

(52) U.S. Cl. 219/121.6

(57) ABSTRACT

A method for treating a coating on a substrate includes depositing a multilayer coating on the substrate and adiabatically heating a portion of the multilayer coating with an energy source.

### GOVERNMENT RIGHTS

This invention was made with Government support under the terms of Contract No. DE-AC36-99GO10337, Subcontract No. ZCL-4-32060-04, awarded by the Department of Energy. The Government may have certain rights in this invention.

### TECHNICAL FIELD

The present disclosure relates generally to a substrate and, more particularly, to a system and method for treating a coating on a substrate.

### BACKGROUND

Thermoelectric materials have been used in many different applications where the extraction and/or storage of energy is advantageous. For example, thermoelectric materials having a high conversion efficiency may be desirable in applications in which heat energy from internal combustion engine exhaust gases may be extracted and converted to electricity to power machine components. The effectiveness of a thermoelectric material in converting electrical energy to heating or cooling energy (i.e., the material's coefficient of performance “COP”), or converting heat energy to electrical energy (i.e., the material's conversion efficiency “η”) depends on the thermoelectric material's dimensionless figure of merit termed “ZT,” where “Z” represents a material characteristic defined as: Z=(S²σ)/λ, and “T” represents the average operating temperature. In the above equation, S is the Seebeck coefficient of the material, σ is the electrical conductivity of the material, and λ is the thermal conductivity of the material.

According to the definition of Z, an independent increase in the Seebeck coefficient and/or the electrical conductivity, or an independent decrease in the thermal conductivity may contribute to a higher ZT. Conventional low ZT thermoelectric materials, also known as bulk thermoelectric materials, may have ZT values that do not exceed 1 at room temperature. Newly developed thermoelectric materials with low dimensional structures have demonstrated a higher figure of merit ZT, which may approach 5 or more. These materials may include zero-dimensional quantum dots, one-dimensional nanowires, two-dimensional quantum well, and superlattice thermoelectric structures.

One method of producing quantum-well nanostructured thin films that has been used with some success is the physical vapor deposition (“PVD”) technique. For example, sputtering is a form of the PVD process in which a coating material is ejected from a source material onto a substrate. Sputtering is a good candidate for large scale production of multi-layered nanostructures due to its high productivity relative to other processes, such as, for example, molecular beam epitaxy. Such substrates are preferably inexpensive, highly electrically resistive, and highly thermally resistive. In some cases, sputtering does not, however, enable the deposited coating material to form a crystalline structure on the underlying substrate when deposited. Instead, material deposited through sputtering may have a substantially amorphous microstructure. Electrical conductivity, however, may be largely dependent upon the thin film coating having a crystallized microstructure.

To solve this problem, post-coating annealing processes are often used to crystallize the deposited coating. Some multilayered nanostructured thin film coating materials have annealing or melting temperatures in excess of 1,600 degrees Celsius. Typical substrate materials, such as polymers, Si, or glass, however, have degradation temperatures well below the melting temperature of such coatings. Thus, most post-coating annealing processes are unable to crystallize the coating layer without damaging the substrate layer.

One method of post-coating treatment involves the process of laser annealing. As described in U.S. Pat. No. 6,740,569 (“the '569 patent”), such processes may be used to fabricate a polysilicon film. The method described in the '569 patent requires the use of a glass substrate. Such substrate materials, however, are considerably more heavy, expensive, and difficult to use than known polymer substrates.

The disclosed system and method is directed to overcoming one or more of the problems set forth above.

### SUMMARY OF THE INVENTION

In one embodiment of the present disclosure, a method for treating a coating on a substrate includes depositing a multilayer coating on the substrate and adiabatically heating a portion of the multilayer coating with an energy source.

In another embodiment of the present disclosure, a method for increasing the electrical conductivity of a multilayer coating includes depositing the multilayer coating on a polymer substrate and increasing the temperature of the multilayer coating to its melting temperature. The method further includes maintaining the temperature of the polymer substrate below a substrate degradation temperature.

In still another embodiment of the present disclosure, a thermoelectric structure includes a first layer having a polymer substrate and a second layer deposited on the first layer. The second layer includes a plurality of alternating layers. The plurality of alternating layers include a primary layer having a primary boron to carbon ratio and a secondary layer having a secondary boron to carbon ratio different than the primary boron to carbon ratio.

### BRIEF DESCRIPTION OF THE DRAWINGS

FIG. 1 is a diagrammatic illustration of a thermoelectric structure and an energy source according to an exemplary embodiment of the present disclosure.

FIG. 2 is a side view of the thermoelectric structure and energy source of FIG. 1.

FIG. 3 is a diagrammatic illustration of an adiabatic heating temperature profile according to an exemplary embodiment of the present disclosure.

### DETAILED DESCRIPTION

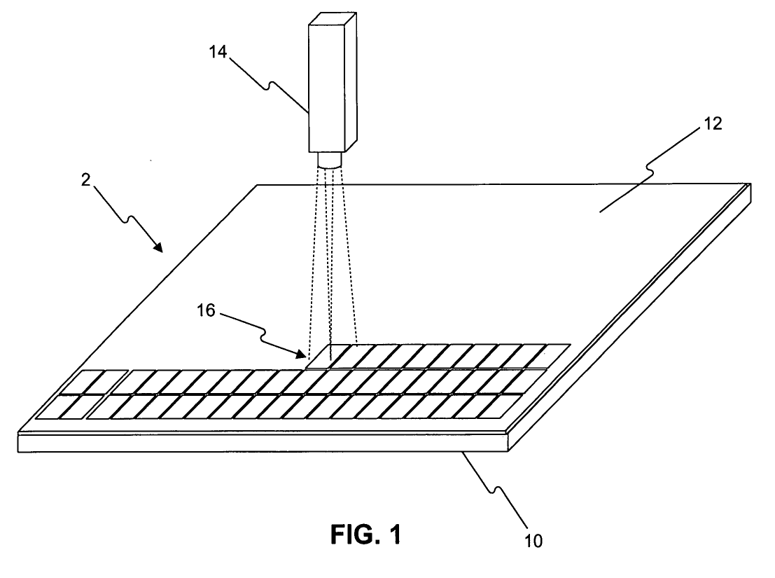

FIG. 1 illustrates an exemplary thermoelectric structure 2 according to one embodiment of the present disclosure. As will be described in greater detail below, the thermoelectric structure 2 may include, for example, a coating 12 deposited on a substrate 10. The substrate 10 may comprise any conventional substrate material such as, for example, polymers, mica, alumina, silicon, germanium, and glass. The substrate materials may be flexible or substantially rigid, and may be appropriate for industrial thermoelectric applications. The substrate materials may have a high electrical and thermal resistance, and may be relatively resistant to the absorption of heat in the form of laser energy. For example, the substrate materials may be substantially transparent to a laser beam having a specific wavelength. The substrate materials may be relatively inexpensive and may be configured to form a substrate 10 having a substantially uniform thickness. In an exemplary embodiment, the substrate 10 may have a thickness of approximately 25 microns. It is understood that the length, width, thickness, transparency, and/or other physical characteristics of the substrate 10 may be desirably chosen depending on the application. In an exemplary embodiment of the present disclosure, the substrate 10 may comprise Kapton®. Substrate materials such as Kapton® may have a degradation temperature of approximately 300 degrees Celsius. In general, the substrate 10 may have a melting or degradation temperature that is substantially lower than the melting or annealing temperature of the coating 12 deposited thereon.

The coating 12 may comprise any ceramic, metallic, and/or other thermoelectric thin film coatings known in the art. For example, the coating 12 may be a multilayer nanostructured thin film coating. Such coatings 12 may include, for example, a boron carbide/boron carbide system, a silicon/silicon germanium system, a lead telluride/bismuth telluride system, and a silicon/silicon carbide system. In an exemplary embodiment of the present disclosure, a boron carbide/boron carbide system may comprise alternating layers of two different boron to carbon ratios. In such an embodiment, the coating 12 may comprise a multilayer coating having alternating layers of B₄C/B₉C. In another exemplary embodiment, a silicon/silicon germanium system may comprise alternating layers of two different silicon to germanium ratios. In such an embodiment, the coating 12 may comprise a multilayer coating having alternating layers of Si/Si₈₀Ge₂₀.

In an exemplary embodiment, the coating 12 may have a thickness in the range of approximately 0.5 to approximately 15 micrometers. It is understood that the thickness and/or other physical characteristics of the coating 12 may be desirably chosen depending on the application. In addition, the coating 12 may have a melting or annealing temperature that is significantly higher than the melting or degradation temperature of the substrate 10. For example, a boron carbide coating of the present disclosure may have a melting temperature of approximately 2450 degrees Celsius or more.

The coating 12 may be deposited on the substrate 10 in any conventional way such that the coating is dispersed substantially uniformly across a surface of the substrate 10. Such deposition processes may include, for example, low pressure chemical vapor deposition, plasma enhanced chemical vapor deposition, electron beam processes, molecular beam epitaxy, and sputtering. In an exemplary embodiment of the present disclosure, a thin film coating 12 may be deposited through a PVD process useful in forming multilayered nanostructured thin film coatings on thin substrates. The PVD technique may be useful in forming such coatings due to its high productivity and the relative ease with which the molecular structure and/or thickness of the individual layers of the coating being deposited may be controlled. It is understood, however, that coating layers deposited using the PVD process may have a disordered or amorphous microstructure. Because the electrical conductivity of the coating 12 may depend upon the coating 12 having an ordered or crystalline microstructure, however, a post-coating annealing process may be performed on coatings deposited through PVD for crystallization.

As shown in FIG. 1, energy may be directed to the coating 12 and/or the substrate 10 by an energy source 14. The energy source 14 may be any source of heat, laser, light, electricity, and/or other energy known in the art. Such energy sources 14 may include, for example, arc-lamps, heaters, and lasers. In an exemplary embodiment of the present disclosure, the energy source 14 may be a nanosecond Q-switched laser source capable of rapidly directing a desired energy density to the coating 12. The nanosecond laser source may be, for example, an Nd YAG laser. Such an exemplary laser source may be capable of emitting a laser beam in pulses of relatively short duration. For example, such pulses may have a duration of less than ten nanoseconds and may deliver approximately 150 to approximately 350 milli-Joules/pulse (i.e., approximately 200 to approximately 5000 milli-Joules/cm²). Such pulses may also have a wavelength of approximately 1,050 to approximately 1,080 nanometers. The laser pulses emitted by the energy source 14 may be long enough in duration and high enough in energy density to melt the coating 12 but may also be short enough in duration and low enough in energy density to cause substantially no damage to the substrate 10.

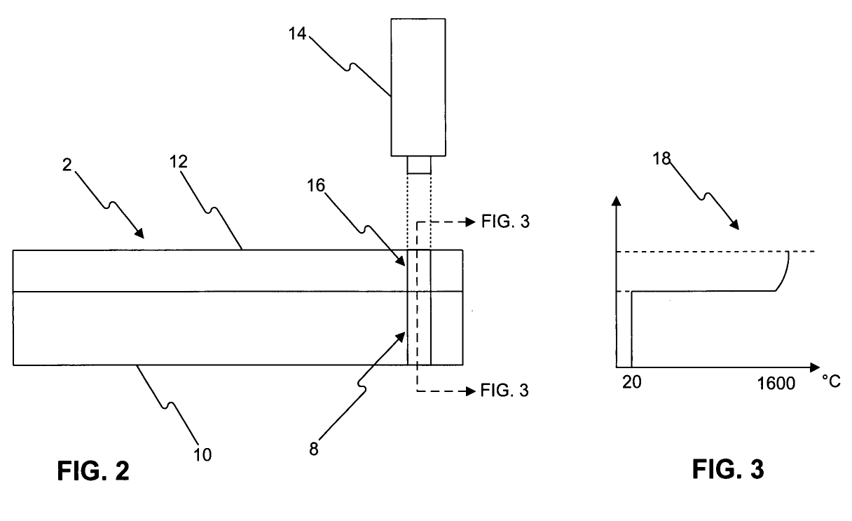

The energy source 14 may be configured to substantially uniformly crystallize the amorphous coating 12 after the coating 12 is deposited on the substrate 10. Accordingly, the energy source 14 may be configured to heat or otherwise increase the temperature of the coating 12 to close to or above its melting temperature through an adiabatic heating process. In such a process, the temperature of the substrate 10 may be maintained below the substrate melting or degradation temperature while the temperature of the heat treated portion 16 is increased to its melting or annealing temperature. As shown in FIGS. 1 and 2, the energy source 14 may be configured to scan a surface of the coating 12 in substantially parallel traces, and the scanning motion and/or focal optics of the energy source 14 may be controlled to produce the heat treated portion 16 of the coating 12. It is understood that the energy source 14 may be configured to substantially uniformly heat treat the coating 12. After the energy source 14 passes over the heat treated portion 16, the melted coating 12 cools rapidly and changes from a substantially amorphous nanostructure to a substantially crystalline nanostructure. The crystallization of coatings 12 comprised of materials such as, for example, boron carbide, may increase the electrical conductivity by two orders of magnitude or more.

An exemplary adiabatic heating temperature profile 18 according to an embodiment of the present disclosure is illustrated in FIG. 3. The exemplary temperature profile 18 of FIG. 3 illustrates the temperature of the heat treated portion 16 of the coating 12 and of an underlying portion 8 of the substrate 10 during the adiabatic heating process. As illustrated in FIG. 3, in an exemplary embodiment, the heat treated portion 16 of the coating may reach temperatures in excess of 1,600 degrees Celsius during heating while the underlying portion 8 of the substrate 10 may be maintained at room temperature. It is also understood that an upper surface of the heat treated portion 16 may have a slightly higher temperature than a region of the heat treated portion 16 disposed closer to the underlying portion 8.

### INDUSTRIAL APPLICABILITY

As discussed above with respect to the thermoelectric structure 2, the methods and processes described herein may be used to treat amorphous multilayered coatings deposited on polymer substrates. The treated thermoelectric structures may be used in a wide array of industries such as, for example, semiconductor industry, consumer electronics, transportation, aerospace, heating, air conditioning, heavy duty machinery and material processing. The treated thermoelectric structures may be used for a variety of purposes such as, for example, heating, cooling, and/or other energy conversion applications. For example, the treated thermoelectric structures described above may be packaged into thermoelectric devices. These thermoelectric devices may be used for solid state cooling where electrical power is provided to the device, and a subsequent temperature differential is created that removes heat from a heat source. Such devices may be applicable in, for example, air conditioning applications, and localized cooling of electronic equipment, laser diodes, and medical devices. These thermoelectric devices may also be used for electric power generation applications. In such applications, the devices may assist in harvesting and/or converting excess thermal energy from exhaust gases into useful electric power. Such exhaust gases may be emitted by, for example, internal combustion engines, jet engines, industrial furnaces, heat treat furnaces, smelting facilities, foundry facilities, fuel cells, and/or geothermal sources.

Other embodiments of the disclosed thermoelectric structure and methods of treatment will be apparent to those skilled in the art from consideration of the specification. For example, a plurality of energy sources may be used to assist in adiabatically heating a portion of the coating. In addition, a cooling system may be used to assist in maintaining the substrate below its degradation temperature during the heat treatment process. Moreover, at least the thermoelectric structure 2 and the energy source 14 may be enclosed within and/or acted upon by a vacuum system to minimize heat losses through convection. The disclosed methods may also be applicable to thermoelectric coating materials other than those mentioned herein. It is intended that the specification and examples be considered as exemplary only, with the true scope of the invention being indicated by the following claims.

What is claimed is:

1. A method for treating a coating on a substrate, comprising:
depositing a multilayer coating on the substrate; and
adiabatically heating a portion of the multilayer coating with an energy source.

2. The method of claim 1, wherein the multilayer coating includes one of a boron carbide/boron carbide system, a silicon/silicon germanium system, a lead telluride/bismuth telluride system, and a silicon/silicon carbide system.

3. The method of claim 1, wherein adiabatically heating the portion of the multilayer coating further includes changing the molecular structure of the portion of the coating from amorphous to crystalline.

4. The method of claim 1, wherein adiabatically heating the portion of the multilayer coating further includes increasing the electrical conductivity of the portion.

5. The method of claim 1, wherein the substrate includes Kapton®.

6. The method of claim 1, wherein depositing the multilayer coating includes a physical vapor deposition process.

7. The method of claim 1, wherein the energy source includes a nanosecond pulsed laser.

8. The method of claim 1, wherein adiabatically heating the portion of the multilayer coating comprises increasing the temperature of the portion to at least the coating melting temperature and maintaining the temperature of the substrate below a substrate degradation temperature.

9. A method for increasing the electrical conductivity of a multilayer coating, comprising:
depositing the multilayer coating on a polymer substrate;
increasing the temperature of the multilayer coating to a coating melting temperature; and
maintaining the temperature of the polymer substrate below a substrate degradation temperature.

10. The method of claim 9, wherein increasing the temperature of the multilayer coating includes an adiabatic heating process.

11. The method of claim 9, wherein increasing the temperature of the multilayer coating includes directing a pulse of laser energy to the coating.

12. The method of claim 9, wherein the multilayer coating includes one of a boron carbide/boron carbide system, a silicon/silicon germanium system, a lead telluride/bismuth telluride system, and a silicon/silicon carbide system.

13. The method of claim 9, wherein the multilayer coating includes a first layer having a first boron to carbon ratio and a second layer having a second boron to carbon ratio different than the first boron to carbon ratio.

14. The method of claim 9, wherein increasing the temperature of the multilayer coating assists in increasing the electrical conductivity of the coating.

15. The method of claim 9, wherein increasing the temperature of the multilayer coating assists in crystallizing a portion of the coating.

16. A thermoelectric structure comprising:
a first layer comprising a polymer substrate;
a second layer deposited on the first layer, the second layer including a plurality of alternating layers, the plurality of alternating layers including a primary layer having a primary boron to carbon ratio and a secondary layer having a secondary boron to carbon ratio different than the primary boron to carbon ratio.

17. The thermoelectric structure of claim 16, wherein the first layer includes Kapton®.

18. The thermoelectric structure of claim 16, the first layer having a degradation temperature of approximately 300 degrees Celsius.

19. The thermoelectric structure of claim 16, wherein the second layer is deposited on the first layer through a physical vapor deposition process.

20. The thermoelectric structure of claim 16, wherein the second layer is heat treated with laser energy.
